(19) United States
(12) Patent Application Publication
(10) Pub. No.: US 2003/0198015 A1
(43) Pub. Date: Oct. 23, 2003

(54) Mobile docking station

(76) Inventor: Edwin Vogt, Boblingen (DE)

Correspondence Address: JAMES J. RALABATE, 5792 MAIN STREET, WILLIAMSVILLE, NY, 14221, US

(21) Appl. No.: 10/126,367

(22) Filed: Apr. 19, 2002

(51) Int. Cl. G06F 1/16

(52) U.S. Cl. 361/686; 710/303

(57) ABSTRACT

The invention provides a modular computer unit that contains all of the conventional components of a general-purpose computer disposed in a single housing with has only a single interface connector on one end of the computer unit. The unit is non-functional unless mated with either a docking stations or connector plate through a reciprocal connector with provides the computer unit with access to power and peripheral devices. The computer unit can be a wearable computer.

### TECHNICAL FIELD

The invention is directed to the field of mobile computers. Specifically, the invention is directed toward the field of wearable and modular computers wherein a computer system is disclosed as being comprised of two or more components. One component houses the essential internal parts of a computer, including CPU, hard disk, memory, bus, etc. and the other component contains all the interface ports required to couple with various external input and output devices.

### BACKGROUND ART

Wearable or user-supported personal computers are known in the art and are becoming increasingly important. Examples of user-supported personal computers include U.S. Pat. No. 5,305,244 (Newman I) which discloses a voice-activated, user-supported computer (mobile computer) and U.S. Pat. No. 5,844,824 (Newman II) which discloses a body-worn, hands-free computer system that does not rely upon keyboard input or activation apparatus both commonly assigned to Xybernaut Corporation of Fairfax, Va. The disclosures of these two commonly owned U.S. Pat. Nos. 5,305,244 and 5,844,824 are hereby incorporated by reference into this disclosure. For the purposes of this disclosure and claims the term “wearable computer” will be taken to mean a computer such as is disclosed in these two patents or a suitable analogous user supported computer disclosed elsewhere. These computers are typically contained within a single housing, which usually connects to an external display. All other essential non-redundant computer components are contained within the single enclosure. A connector port is usually disposed on at least one face of the enclosure with various connectors for external input and output devices. The computer casing is also designed with attachment means such as belt loop bracket or clip so that the casing may be easily attached to the body of a user.

Also disclosing wearable computers are U.S. Pat. Nos. 5,285,398 (Janik I), 5,491,651 (Janik II), 5,581,492 (Janik III), 5,798,907 (Janik IV), 5,555,490 (Carroll I) and 5,572,401 (Carroll II). Each Janik patent discloses a belt computer containing the elements or components of a computer. For example, in Janik I, the plurality of computing elements are located on the belt and a flexible signal relaying means connects all of the elements for computing. A protective covering is used for enclosing said computer elements. In Janik II, a similar belt computer is described and claimed in which the signal relaying means, the length of which between any two computing elements, is greater than the length of the wearable member between any two computing elements. In each Janik patent, the flexible wearable computer is in the form of a relatively heavy belt comprising around its periphery sequentially positioned computer elements.

Both Carroll I and Carroll II disclose a wearable support and interconnection structure for a modular microcomputer system having a plurality of microcomputer cards housed in a plurality of microcomputer card pockets in a wearable garment. Examples of such garments include a pliable garment worn over the torso of the user (vest), a cap that fits snugly on user's head or in the form of a belt. In one embodiment, the pockets are linked by a plurality of channels extending from pocket to pocket that secure an electronic linking system to the wearable garment. The linking system includes a plurality of flat flexible cables encasing flexible circuitry and microcomputer card connectors. A card connector opens into each pocket to receive a microcomputer card. Each connector is operable, coupled to the cables such that when microcomputer cards are placed in the connectors and provided with power, an operational microcomputer system is created.

In commonly owned U.S. Pat. No. 5,999,952 and U.S. Pat. No. 6,029,183 a core computer unit is disclosed wherein the core unit being a single completely closed housing having internally therein components of a fully function conventional computer such as a CPU, RAM, hard drive and perhaps minimal video and audio and other peripheral controllers, such as keyboard and mouse controllers all enclosed in a single sealed enclosure. The core has a single connector that mates with a plurality of enclosures and has no useable interface on its exterior. However, the enclosures are required to be either directly or indirectly connected to another structure such as the console of a car, test equipment, house electrical system, other computers, etc.

Nelson et al, U.S. Pat. No. 5,436,857 (herein after Nelson), teaches a computer module which is used with a desktop and portable (laptop) base unit. The functional components of the computer are divided between the interchangeable module and the base units, such that the module containing a processor memory and disk can be removed from the desktop base unit, taken away from the location of the desktop base unit, and inserted into a portable base unit. In this manner, information stored in the hard disk of the desktop base unit will be available in the portable or other desktop base units and visa versa. The Nelson system differs from that of the present invention in that the functional components are divided between the module and the base unit where as the system of the present invention has all the functional components of a computer except for the interface. Therefore, all controllers and other hardware are in the core of the present invention. Nelson divides these components, Col. 2, lines 22-24. Additionally, Nelson's module is not a sealed module as taught by the present invention. Nelson's module allows selective removal of components, Col. 3, lines 26-28.

Wallsten, WO 92/18924, also discloses a module based computer system. The system of Wallsten utilizes a computer system comprised of two inter-connectable parts, a detachable module and a docking station, wherein the module consists of a CPU, memory and disk, and the docking station consists of a power supply, electronic components for driving the peripheral equipment such as monitor and keyboard, printer. The module is designed to be portable between and dockable in different docking stations such that when the two are joined together they form an integral unit. However, the docking station of Wallsten (page 4, line 24) is mainly intended for stationary installation at a work site. Furthermore, Wallsten is silent on whether the module itself is a sealed enclosure.

Flint, U.S. Pat. No. 5,608,608, teaches a computer system comprised of a cartridge and a plurality of user interface modules (chassis'). The cartridge itself contains a processor, memory coupled to a bus and a slot for a card, such as a communications card, such that the module can take on at least a first and second form. This differs from the computer of the present invention, which is a sealed case, not permitting changes to be made to the module.

Further, IBM has developed a device called “Meta Pad” which is a 9-ounce, wallet-size computer containing a processor, a hard drive, memory, and docking connector that can be inserted into a number of different computer-hardware modules. The Meta Pad is devoid of a power supply, display, and I/O connectors.

As computers evolve they tend to be less compatible with older or “legacy” systems and often need upgrading as newer interfaces become available. For example, computer makes have gone away from the Industry Standard Architecture (ISA) devices because they do not adhere to the plug and play standard. However, many individuals and corporations have incurred great expense in maintaining these older systems and are reluctant to convert over to a newer interface. In order to use these older devices with modern computers, an adapter would be needed to make a COMM port, for instance, work with a USB. Moreover, as new interfaces become available, the user would have to remove the old board with the out-of-date connector(s) and replace it with a newer board possibly with a new standard interface in order to use the latest hardware and software.

Therefore there is a need for a wearable computer or user-supported system which is designed in a modular architecture to be used in both wearable and non-wearable configurations. Such a computer will rely upon an interface connector port which mates with the base computer system defining the number and type of peripheral connections, which can be mated with the computer. The connector port also serves as a means of interconnection between the computer and a docking station.

### SUMMARY OF INVENTION

It is therefore an object of this invention to provide a computer system, which is devoid of the aforementioned shortcomings.

It is another object of this invention to provide a modular computer system.

It is still another object of this invention to provide a wearable computer system with means for attaching the computer to the body of a user such that it can be worn and used simultaneously.

It is yet another object of this invention to provide a computer system, which is comprised of three components.

It is an additional object of this invention to provide a computer system, which can be used in a desktop mode when mated with a desktop docking station.

It is still an additional object of this invention to provide a computer system, which possesses a single interface connector port.

These and additional objects of the present invention are accomplished generally by a computer system of the present invention that will be essentially comprised of three components, a computer unit, a peripheral access module and a docking station. The computer itself will possess a single interface connector port disposed on one end face and will preferably be contained within a single sealed enclosure. The attachment means will interface with the computer unit. The computer is non-functional unless connected to the connector unit or to the docking station.

The mobile computer will comprise the essential components of a general-purpose computer including CPU, storage means either flash or rotating media, memory, rechargeable batteries, etc. all contained in a single enclosure with an interface connector port disposed on one end face. Preferably, the interface connector port is about 160 pins, however, any suitable pin configuration can be used. Alternatively, the computer will be enabled to perform communication functions such as cellular, hardwire telephone communication, radiofrequency, infrared, laser or fiberoptic transceiver either through hardwiring or by way of compact flash.

In one embodiment of the present invention, a single enclosure wearable computer is mated with a peripheral access module through a single interface connector port. The peripheral access module will have on one end a female single interface connector and on the other end will be a variety of different ports such as display ports for either a conventional display such as a CRT or LCD, for a head or wrist mounted display, or for a neck hung or user-supported display. Other ports such as custom/user defined, USB, serial, parallel, and any other ISA device, as well as any future ports will be contained within the transferable connector to be used with the mobile computer.

In an alternative embodiment of the present invention, a single enclosure wearable computer is mated with a docking station through the single interface connector port. The docking station contains a media bay which houses devices such as CD-ROM, CD-RW/DVD combo, secondary mass storage, power supply port, and other PC-type connectors such as USB, parallel, serial, firewire, etc.

The foregoing and additional objects and advantages of the invention together with the structure characteristics thereof, which is only briefly summarized in the foregoing passages, becomes more apparent to those skilled in the art upon reading the detailed description and preferred embodiments, which follow in this specification, taken together with the illustration thereof presented in the representative accompanying drawings.

### BRIEF DESCRIPTION OF THE DRAWINGS

FIG. 1 illustrates a block diagram of the internal components of the mobile computer of the present invention.

FIG. 2 illustrates a first embodiment of the present invention comprising a mobile computer with a transferable connector plate.

FIG. 3A illustrates a side view of the second embodiment of the present invention comprising a mobile computer docked with a docking station.

FIG. 3B illustrates a rear view of the second embodiment of the present invention comprising a mobile computer docked with a docking station.

### DETAILED DESCRIPTION OF THE INVENTION AND PREFERRED EMBODIMENTS

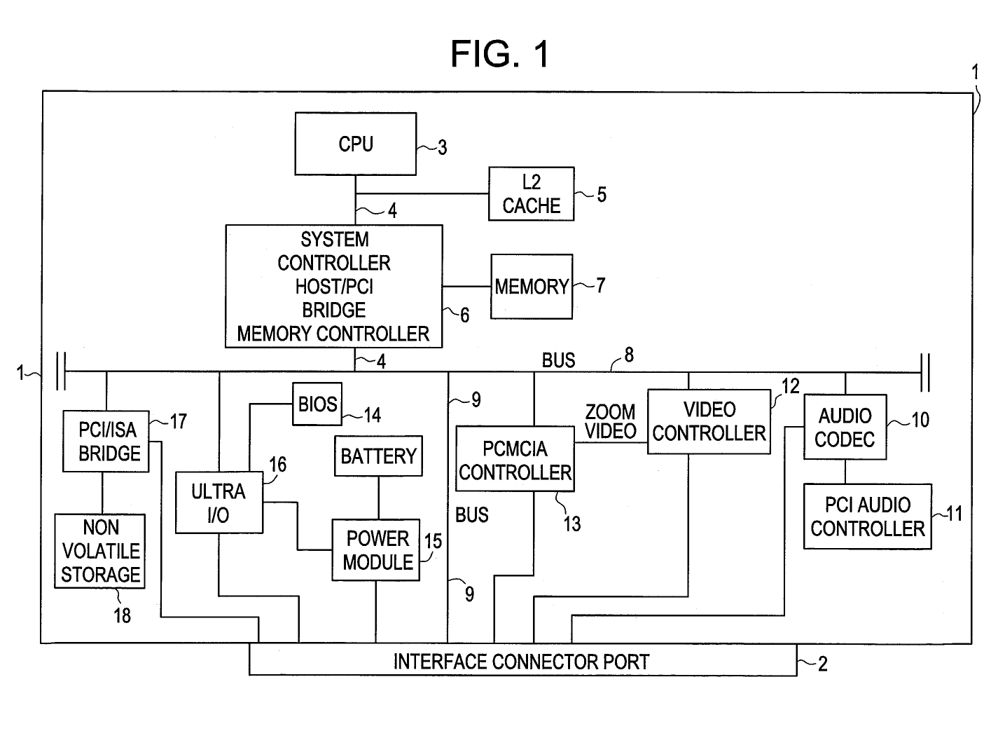

Discussion of the invention will now be made with specific references to the drawing figures. In FIG. 1, an exemplary block diagram of the internal components and external interface connector port 2 of the mobile computer 1 of this invention is shown. Preferably, the computer housing completely encloses all of the internal components of the computer so that it becomes tamper-proof. On the other hand, no other components can be user added to the internal structure of totally enclosed computer unit. The only external functional components of the mobile computer is the connector port 2 which mates with and when functional is in contact with connector of the docking station 27 or peripheral access module 19. The microprocessor or CPU 3 is shown connected to the local BUS 4 which also provides the communication with the high speed Level 2 Cache 5. Also on local BUS is the system and memory controller (with host-PCI Bridge) 6. A computer memory 7 is in contact with system controller 6. A second BUS 8 and third BUS 9 are used as peripheral component interconnectors (PCI); however, are not a local BUS since they do not connect directly with the microprocessor. These PCI's are either 32 bit bus that runs at a clock speed of 33 MHz yielding a throughput rate of 132 megabytes per second or 64 bit bus runs at a clock speed of 66 MHz yielding a throughput rate of 528 megabytes per second; however, any suitable bus structure may be used, including 100 MHz buses and beyond. On BUS 8 is connected an Audio Coder 10 or Audio Coder PCI audio controller decoder 11. Also connected to BUS 8 is a video controller 12, which handles all display functions. The PCMCIA controller 13 acts as the PCMCIA interface to the PC card subsystem. The BIOS 14 provides low level functions used for accessing peripherals to the system. A power module 15 supplies power to the entire computer system. The Input/Output interface 16 provides all input/output functions for the system. The legacy bridge 17 is the bridge to all ISA to PCI capability. The non-volatile storage 18 provides hard drives and non-rotating memory such as flash. The computer connector 2 provides for electrical contact to the reciprocal connector of the docking station 19 or peripheral access module 27.

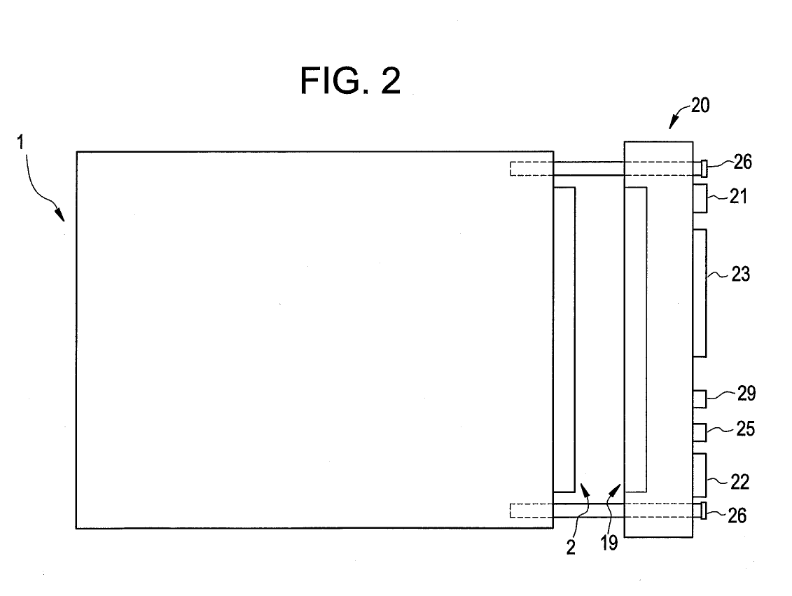

FIG. 2 illustrates an embodiment of the instant invention comprising a mobile computer 1 with a peripheral access module 20. The mobile or wearable computer 1 and the peripheral access module 20 are mated through an interface connector port 2. Preferably, the interface connector port 2 is about a 160 pin connector; however, any suitable pin configuration can be used. The peripheral access module has a reciprocal interface connector port 19 on one end and a plurality of ports on the other end. For example, shown on the peripheral access module contains ports for universal serial bus (USB) 21, communications serial ports (COM) 22, LPT 23, power 24, and display 26. The display can be either a conventional display such as a CRT or LCD, or a head or wrist mounted display, or a neck hung or user-supported display. The peripheral access module can be customized to provide the user with access to unique legacy or ISA devices as well as any future standard since the interface connector port 2 remains static. The peripheral access module is removably secured to the mobile connector by means of screws 26 or any other suitable type of connector.

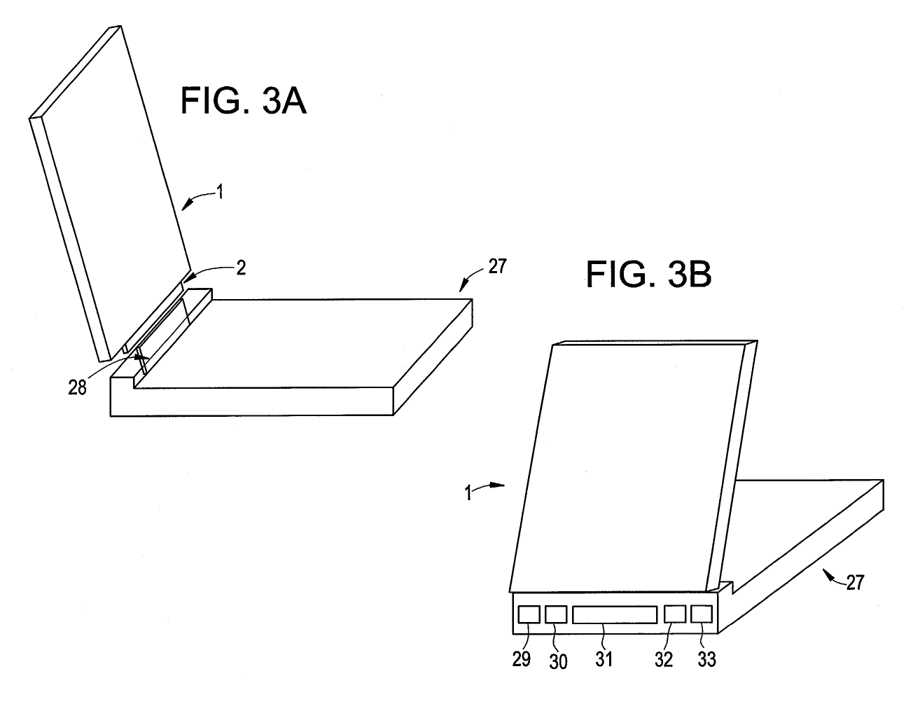

FIG. 3A illustrates a side view of the second embodiment of the instant invention comprising a mobile computer 1 with a docking station 27. When the computer 1 is docked with the docking station 27 by means of the interface connector port 2 into reciprocal port 28, the docking station provides the computer with power, additional media bays, and peripheral devices. As shown in FIG. 3A, the computer 1 is vertically docked into the docking station 27. The docking station 27 contains components such as CD-RW/DVD combo drive, secondary mass storage such as rotating media in the form of a hard drive or non-rotating such as compact flash, and floppy drive. FIG. 3B illustrates a rear view of the second embodiment showing the ports the docking station. The docking station 27 also provides the computer with additional ports such as communications 29, serial 30, printer (LPT) 31, display 32, as well as power 33. These are only illustrative and it is envisioned that any ports on a conventional laptop computer would be included.

The present embodiments of this invention are thus to be considered in all respects as illustrative and not restrictive; the scope of the invention being indicated by the appended claims rather than by the foregoing description. All changes that come within the meaning and range of equivalency of the claims are intended to be embraced therein.

I claim

1. A computer system comprising:
a computer unit comprising a computer motherboard containing essentially all the components of a general purpose computer system, said components including a CPU, volatile and non-volatile storage, I/O controller, audio controller and video controller all in electrical contact and all contained within a single enclosure; said enclosure having therein a single interface connector disposed on one end of said enclosure said interface connector in electrical contact with said computer motherboard.

2. The computer system of claim 1, wherein said enclosure is absent any additional ports.

3. The computer system of claim 1, wherein said computer unit is a wearable or user supported computer.

4. The computer system of claim 1, wherein said interface connector consists of about 160 pins.

5. The computer system of claim 1, wherein said computer unit is sealed.

6. The computer system of claim 1 wherein said computer unit has the capability for communicating and interacting with a communication module selected from the group consisting of cellular telephones, hard line telephones, infrared transceivers, two-way radio means and mixtures thereof.

7. A computer system comprising:
a computer unit comprising a CPU, non-volatile memory, hard drive, rechargeable battery all in electrical contact and all contained within a single enclosure; said enclosure having therein a single interface connector disposed on one end of said enclosure;
a connector plate with a reciprocal interface connector that when mated with said computer unit provides said computer unit with peripheral computer ports.

8. The computer system of claim 7 wherein the peripheral computer ports comprises communication, serial, parallel, and display.

9. The computer system of claim 8 wherein the display ports are selected from the group consisting of neck hung, wrist mounted, head mounted, and mixtures thereof.

10. The computer system of claim 7 where in the computer unit is sealed.

11. The computer system of claim 7 wherein the computer unit is a wearable or user supported computer.

12. The computer system of claim 7 wherein said computer unit has the capability for communicating and interacting with a communication module selected from the group consisting of cellular telephones, hard line telephones, infrared transceivers, two-way radio means and mixtures thereof.

13. A computer system comprising:
a computer unit comprising a CPU, non-volatile memory, hard drive, rechargeable battery all in electrical contact and all contained within a single enclosure; said enclosure having therein a single interface connector disposed on one end of said enclosure;
a docking station with a reciprocal interface connector that when mated with said computer unit provides said computer unit with peripheral computer ports.

14. The computer system of claim 13 wherein the peripheral computer ports comprises communication, serial, parallel, and display.

15. The computer system of claim 14 wherein the display ports are selected from the group consisting of neck hung, wrist mounted, head mounted, CRT, LCD, and mixtures thereof.

16. The computer system of claim 13 wherein the computer unit is sealed.

17. The computer system of claim 13 wherein the computer unit is a wearable or user supported computer.

18. The computer system of claim 13 wherein said computer unit has the capability for communicating and interacting with a communication module selected from the group consisting of cellular telephones, hard line telephones, infrared transceivers, two-way radio means and mixtures thereof.
